(19) United States
(12) Patent Application Publication
(10) Pub. No.: US 2012/0195548 A1
(43) Pub. Date: Aug. 2, 2012

(54) BACKPLANES INCLUDING OPTICAL BYPASS SWITCHES, AND RELATED CIRCUIT BOARDS, COMPUTING SYSTEMS, BYPASS SWITCHES, AND METHODS

(75) Inventors: Robert Brunner, Montreal (CA); Stephane Lessard, Mirabel (CA)

(73) Assignee: TELEFONAKTIEBOLAGET L M ERICSSON (PUBL), Stockholm (SE)

(21) Appl. No.: 13/016,501

(22) Filed: Jan. 28, 2011

(51) Int. Cl. G02B 6/26

(52) U.S. Cl. 385/18; 385/16

(57) ABSTRACT

A backplane for a computing system may include a connector configured to provide a detachable mechanical coupling with a circuit board, and an optical signal path configured to carry optical signals. In addition, an optical bypass switch may be configured to couple optical signals from the optical signal path to the circuit board and to couple optical signals from the circuit board to the optical signal path responsive to an enabling signal. The optical bypass switch may be further configured to transmit optical signals therethrough to bypass the circuit board responsive to an absence of the enabling signal. Related circuit boards, computing systems, bypass switches, and methods are also discussed.

### TECHNICAL FIELD

The present disclosure is directed to electronics and, more particularly, to optically coupled electronic devices and related methods.

### BACKGROUND

In a networked computer system, a plurality of circuit boards may be networked through a backplane in an enclosure. In such a system, each circuit board may be detachably coupled to the backplane to facilitate physical insertion/removal of the circuit board. Accordingly, circuit boards may be added to the computer system relatively easily to increase/change functionality/capacity, to replace malfunctioning circuit boards, to provide customized functionality, etc. Electrical network connections between circuit boards may be provided through the backplane. Moreover, the backplane and/or the enclosure may provide centralized power, management, and cooling, for the plurality of circuit boards networked through the backplane. Each circuit board, for example, may function as a server, and the circuit board servers may be referred to as blade servers.

In some networked computer systems, optical network connections may be provided between the circuit boards in addition to electrical network connections provided through the backplane. To provide these optical network connections, however, manual connections of optical cables/fibers may be required when circuit boards are removed from and/or added to the computer system. When adding a new circuit board, for example, an optical cable/fiber between two existing circuit boards may be manually removed, and optical cables/fibers may be manually connected between the new circuit board and each of the previously existing circuit boards. Similarly, when removing a circuit board, existing cable/fiber connections to the circuit board may be manually removed, and a new cable/fiber may be manually connected between the adjacent remaining circuit boards. Accordingly, interruption of the optical network connections to all circuit boards may occur when any one circuit board is added to or removed from the computer system thereby interrupting operations of all of the circuit boards. Moreover, errors from manually connecting/reconnecting optical cables/fibers may result in malfunctions.

### SUMMARY

According to some embodiments, a computing system may include a circuit board including an optical coupler, and a backplane. The backplane may include a connector providing a detachable mechanical coupling with the circuit board, an optical signal path configured to carry optical signals, and an optical bypass switch. The optical bypass switch may be configured to couple optical signals from the optical signal path to the optical coupler of the circuit board and to couple optical signals from the optical coupler of the circuit board to the optical signal path responsive to an enabling signal. The optical bypass switch may be further configured to transmit optical signals therethrough to bypass the circuit board responsive to an absence of the enabling signal.

By providing an optical bypass switch, manual connections between the circuit board and the optical signal path are not required. Accordingly, time required to add and/or remove circuit boards from the computing system may be reduced, and the potential for errors relating to manual connections of optical cables/fibers may be reduced. Moreover, the optical bypass switch may allow addition and/or removal of circuit boards without significantly interrupting traffic between other circuit boards along the optical signal path. Accordingly, circuit boards may be removed from and/or added to the computer system without shutting the computer system down and/or without significantly interfering with operations of other circuit boards or optical communications therebetween.

According to some other embodiments, a backplane for a computing system may include a connector configured to provide a detachable mechanical coupling with a circuit board, an optical signal path configured to carry optical signals, and an optical bypass switch. The optical bypass switch may be configured to couple optical signals from the optical signal path to the circuit board and to couple optical signals from the circuit board to the optical signal path responsive to an enabling signal. The optical signal path may be further configured to transmit optical signals therethrough to bypass the circuit board responsive to an absence of the enabling signal.

According to some other embodiments, a circuit board may be configured to operate in a computing system including an electrical connector, an optical signal path, and an optical bypass switch. The optical bypass switch may be configured to couple optical signals from the optical signal path to the circuit board and to couple optical signals from the circuit board to the optical signal path responsive to an enabling signal, and to transmit optical signals through the optical bypass switch to bypass the circuit board responsive to an absence of the enabling signal. More particularly, the circuit board may include an electrical connector, an optical coupler, and a controller electrically coupled to the electrical connector and to the optical coupler. The electrical connector may be configured to provide a detachable electrical coupling with the electrical connector of the computing system. The optical coupler may be configured to provide an optical coupling with the optical path through the optical bypass switch of the computing system, with the optical coupler including a detector configured to receive optical signals from the optical bypass switch and an emitter configured to transmit optical signals to the optical bypass switch. The controller may be configured to provide verification information through the electrical connector to the computing system without providing the enabling signal, and to provide the enabling signal for the optical bypass switch responsive to receiving authorization from the computing system.

According to some other embodiments, an optical bypass circuit may include a body configured to provide optical coupling with input optical signals and with output optical signals, a first mirror adjacent the input optical signals, and a second mirror adjacent the output optical signals. The first mirror may be configured to provide optical coupling between the input optical signals and an optical detector outside the body responsive to an enabling signal, and the first mirror may be configured to optically bypass the optical detector responsive to an absence of the enabling signal. The second mirror may be configured to provide optical coupling between an optical emitter and the output optical signals responsive to the enabling signal, and the second mirror may be configured to optically bypass the optical emitter responsive to the absence of the enabling signal.

According to some other embodiments, a computing system may include a backplane including a connector configured to provide a detachable mechanical coupling with a circuit board, an optical signal path, and an optical bypass switch serially coupled along the optical signal path. A method of operating such a computer system may include verifying compatibility of the circuit board with the computing system responsive to detecting a presence of the circuit board while carrying optical signals through the optical signal path bypassing the circuit board through optical bypass switch. Responsive to verifying compatibility, authorization may be provided for the circuit board to communicate over the optical signal path. Responsive to the authorization, the optical bypass switch may be actuated to couple the circuit board to the optical signal path through the optical bypass switch.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 is a plan view of a backplane of an electronics enclosure configured to receive a plurality of optically coupled circuit boards according to some embodiments;

FIGS. 2A and 2B are perspective views of an optical bypass switch of the backplane of FIG. 1 according to some embodiments;

FIG. 3 is a plan view of an electronic circuit board configured to optically couple with the backplane of FIG. 1 according to some embodiments;

FIG. 4 is a plan view of the backplane of FIG. 1 populated with a plurality of electronic circuit boards mechanically and optically coupled thereto according to some embodiments;

FIG. 5 is a cross sectional view of the backplane and the electronic circuit boards of FIG. 4 taken along section line v-v′ according to some embodiments;

FIG. 6 is a cross sectional view of the backplane and the electronic circuit boards of FIG. 4 taken along section line vi-vi′ according to some embodiments;

FIG. 7 is a plan view illustrating a plurality of optical signal paths and optical bypass switches according to some embodiments;

FIG. 8 is a plan view of an optical coupler providing coupling with a plurality of optical signal paths according to some embodiments; and

FIGS. 9 and 10 are flow charts illustrating operations of optical computing systems according to some embodiments.

### DETAILED DESCRIPTION

The invention will now be described more fully hereinafter with reference to the accompanying drawings, in which examples of embodiments of the invention are shown. This invention may, however, be embodied in many different forms and should not be construed as limited to the embodiments set forth herein. It should also be noted that these embodiments are not mutually exclusive. Components from one embodiment may be tacitly assumed to be present/used in another embodiment.

As discussed in greater detail below, a networked computing system may include a plurality of circuit boards (also referred to as blades or blade circuit boards) networked through a backplane of an enclosure. Each circuit board, for example, may include a printed circuit board (PCB) populated with electronic components providing functionality of a server, and a circuit board providing such functionality may be referred to as a blade server. The backplane may provide electrical and/or optical coupling between the circuit boards. More particularly, the backplane may include a multilayer printed circuit board (PCB) with a detachable electrical and mechanical connection for each of the circuit boards so that the circuit boards may be easily added, removed, replaced, etc. Moreover, the enclosure and/or backplane may provide power, cooling, networking, and/or management functionality for the circuit boards connected/coupled thereto.

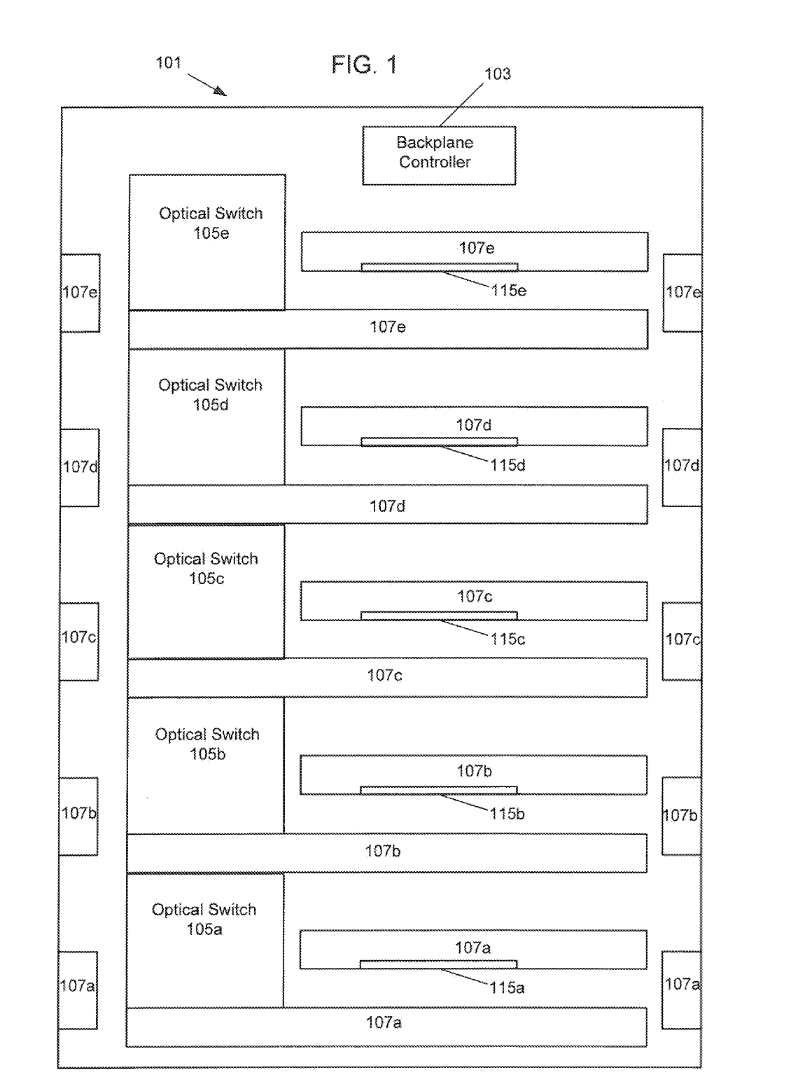

As shown in the plan view of FIG. 1, backplane 101 may be configured to receive a plurality of optically coupled circuit boards 301a-e (shown in FIGS. 3-6) using detachable mechanical connectors 107a to 107e. By using detachable mechanical connectors 107a to 107e to provide detachable mechanical couplings with respective circuit boards, circuit boards may be added and/or removed to change the capacity/speed of the computing network, to change the functionality of the computing network, to repair the computing network, etc. While five mechanical couplings 107a to 107e are shown by way of example, any number of mechanical couplings may be provided for any number of respective circuit boards.

Each detachable mechanical connector 107a to 107e may provide a detachable mechanical connection between a respective circuit board 301a to 301e and backplane 101 as well as alignment between elements (e.g., electrical connectors, optical couplers, etc.) of respective circuit boards and backplane 101. In embodiments of FIG. 1, for example, each mechanical connector may include four segments with upper and lower segments providing alignment/support in a first direction (e.g., a vertical direction of FIG. 1) and with left and right segments providing alignment/support in a second direction (e.g., a horizontal direction of FIG. 1). While separate segments are shown by way of example in FIG. 1, each connector 107a to 107e may be continuous surrounding a slot into which a respective circuit board is to be inserted.

Moreover, each mechanical connector 107a-e may include a respective electrical connector 115a to 115e providing a detachable electrical coupling with a circuit board coupled thereto. Electrical connectors 115a to 115e may thus provide networked electrical couplings between circuit boards and/or backplane controller 103. Backplane controller 103, for example, may be configured to provide network management and/or control for a plurality of circuit boards coupled to electrical connectors 115a to 115e. Mechanical connectors 107a to 107e and electrical connectors 115a to 115e may be integrated, for example, with the mechanical connectors providing alignment of circuit boards with respect to electrical connectors 115a to 115e. According to other embodiments, mechanical connectors 107a to 107e and electrical connectors 115a to 115e may be provided separately. While not shown in FIG. 1, backplane 101 may be provided in an enclosure including a rack/chassis with rails providing additional support/alignment for insertion/removal of circuit boards to/from mechanical connectors 107a to 107e.

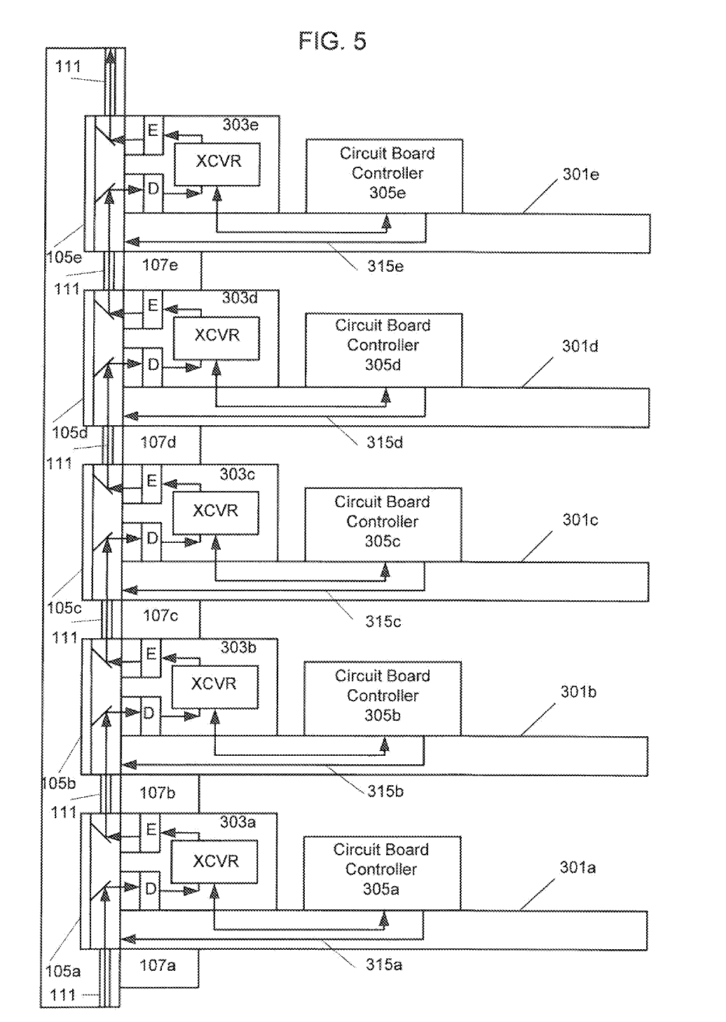

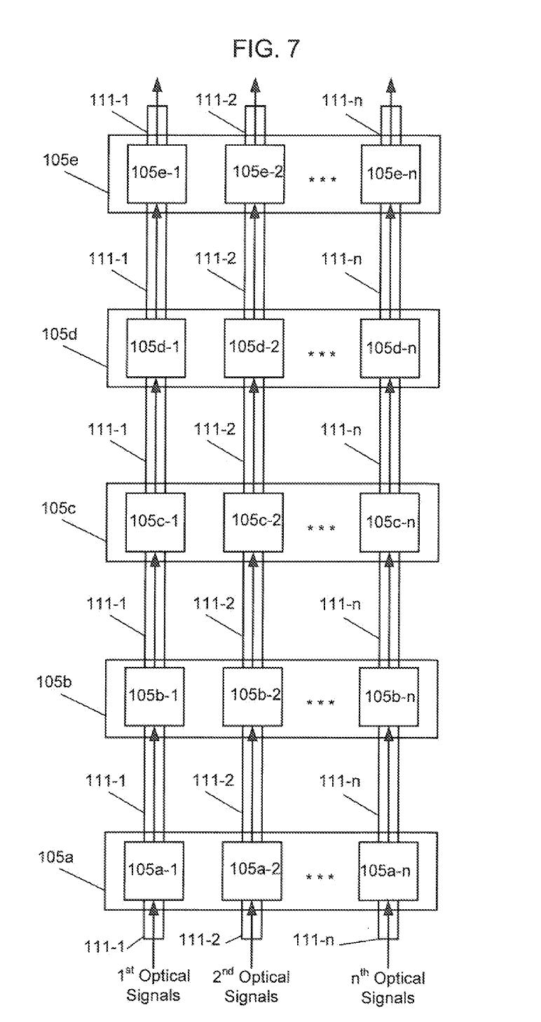

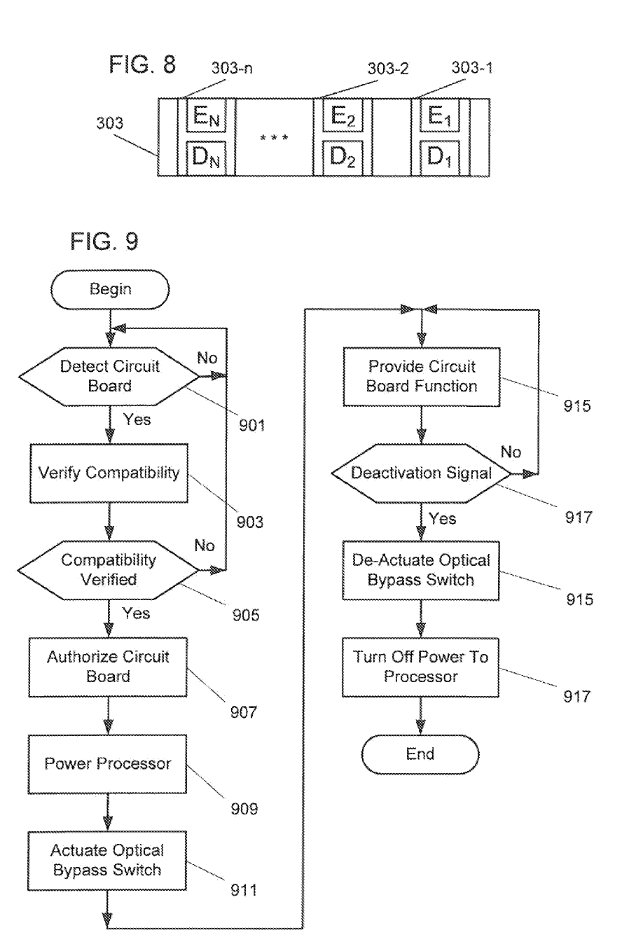

Backplane 101 may also include optical signal path 111 (shown in FIGS. 5 and 7) that is configured to carry optical signals. Moreover, optical bypass switches 105a to 105e may be provided for respective mechanical connectors 107a to 107e, and optical bypass switches 105a to 105e may be serially coupled along optical signal path 111. Mechanical connectors 107a to 107e, for example, may provide alignment between circuit boards 301a to 301e and respective optical bypass switches 105a to 105e, and between circuit boards 301a to 301e and respective electrical connectors 115a to 115e. Each optical bypass switch 105 may be configured to couple optical signals from optical signal path 111 to a respective circuit board and to couple optical signals from the respective circuit board to optical signal path 111 responsive to a respective enabling signal. In the absence of the respective enabling signal, optical signals may be transmitted through optical bypass switch 105 to bypass the respective circuit board. Accordingly, circuit boards may be selectively optically coupled and decoupled to/from optical path 111 using optical bypass switches 105a to 105e. As discussed in greater detail below with respect to FIGS. 7 and 8, backplane 101 may include a plurality of parallel optical signal paths, in which case, each optical bypass switch 105a to 105e may include a respective plurality of separately operable optical bypass switches.

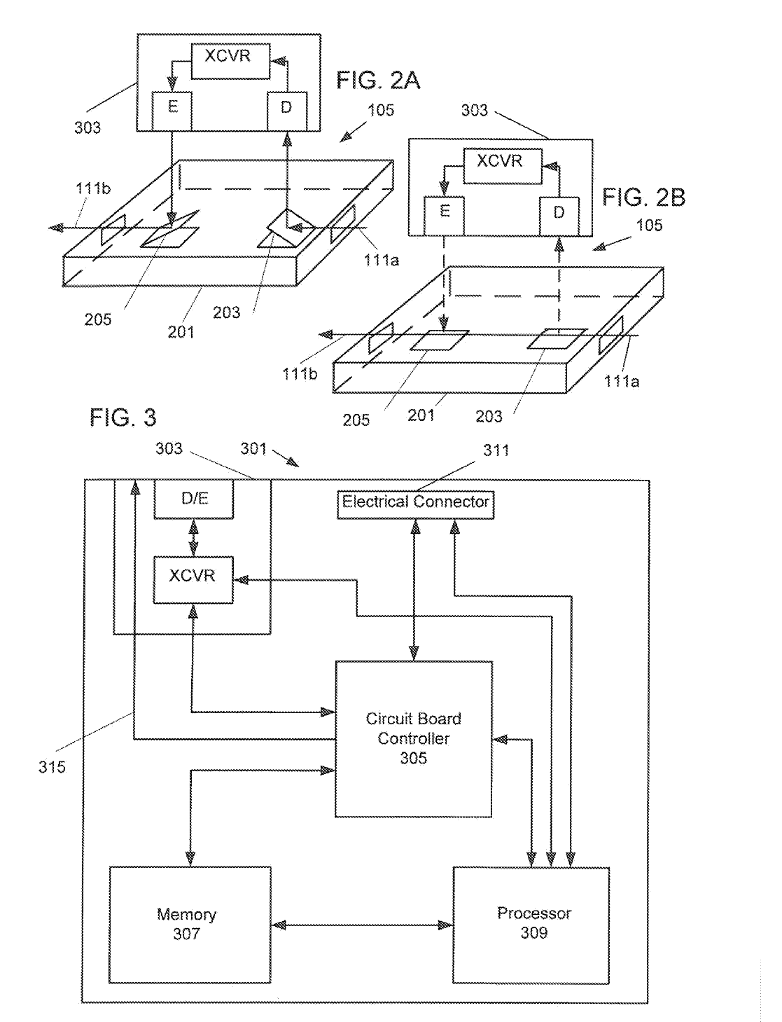

As shown in the perspective views of FIGS. 2A and 2B, each optical bypass switch 105 may include first and second mirrors 203 and 205 (also referred to as input and output mirrors) provided in body 201. Moreover, first and second mirrors 203 and 205 may be configured to actuate responsive to the enabling signal as shown in FIG. 2A, and first and second mirror 203 and 205 may be configured to de-actuate responsive to the absence of the enabling signal as shown in FIG. 2B. Mirrors 203 and 205, for example, may be microelectromechanical systems (MEMS) mirrors that are actuated electrostatically, magnetically, electrically, etc. When actuated responsive to an enabling signal as shown in FIG. 2A, first mirror 203 may be configured to reflect input optical signals 111a from optical signal path 111 to detector D of optical coupler 303 for the respective circuit board, and second mirror 205 may be configured to reflect optical signals from emitter E of optical coupler 303 for the respective circuit board as output optical signals 111b to optical signal path 111. When de-actuated responsive to an absence of the enabling signal as shown in FIG. 2B, first and second mirrors 203 and 205 may be configured to allow passage of input optical signals 111a from the optical signal path 111 as output optical signals 111b without reflecting the optical signals from and to optical coupler 303. Dashed lines shown in FIG. 2B between mirrors 203/205 and detector/emitter 105 illustrate the absence of optical coupling between optical signal path 111 and optical coupler 303. While MEMS structures are discussed by way of example with respect to embodiments of FIGS. 2A and 2B, optical bypass switches 105 may be implemented using other structures/technologies. For example, mirrors 203 and 205 may be implemented using liquid crystal display (LCD) structures/layers to modulate reflectivity of a static mirror structure.

Optical bypass switches 105a to 105e may be integrated in and/or on backplane 101. For example, optical bypass switches 105a to 105e may be manufactured separately from backplane 101 and then mounted in recesses of backplane 101 so that exposed surfaces of backplane 101 and optical bypass switches 105a to 105e are substantially flush as shown in FIG. 5. According to other embodiments, optical bypass switches 105a to 105e may be manufactured separately from backplane 101 and then mounted on a surface of backplane 101. Similarly, optical path 111 may be provided as optical fibers and/or light conductive polymer traces laminated between layers of backplane 101 and/or provided on a surface of backplane 101.

FIG. 3 is a plan view of electronic circuit board 301 configured to optically couple with the backplane of FIG. 1 according to some embodiments. As shown in FIG. 3, circuit board 301 (also referred to as a blade or a blade circuit board) may include optical coupler 303, circuit board controller 305, memory 307, processor 309, and electrical connector 311. Electrical connector 311 may be configured to provide a detachable electrical coupling with a respective electrical connector 115 of backplane 101. Optical coupler 303 may be configured to provide an optical coupling with optical path 111 through a respective optical bypass switch 105 of backplane 101. Functional elements of circuit board 301 may be implemented using discrete and/or integrated circuits mounted on a multilayer printed circuit board with electrical couplings between elements provided using metal interconnections printed in/on the printed circuit board.

More particularly, optical coupler 303 may include: detector D configured to receive optical signals from the optical bypass switch 105 and to convert the optical signals to electrical signals; emitter E configured to convert electrical signals to optical signals and to transmit the optical signals to optical bypass switch 105; and transceiver XCVR configured to provide electrical communication between detector D, emitter E, circuit board controller 305, and/or processor 309. As shown in FIGS. 2A and 2B, detector D may be configured to receive optical signals reflected by first mirror 203 of optical bypass switch 105, and to convert the optical signals into electrical signals that are provided to transceiver XCVR. Emitter E may be configured to convert electrical signals from transceiver XCVR into optical signals, and to transmit the optical signals to second mirror 205 of optical bypass switch 105. Detector D and emitter E are shown together in FIG. 3 because emitter E is located on top of detector D in the plan view of FIG. 3, but emitter E and detector D are shown separately in the cross sectional view of FIG. 5.

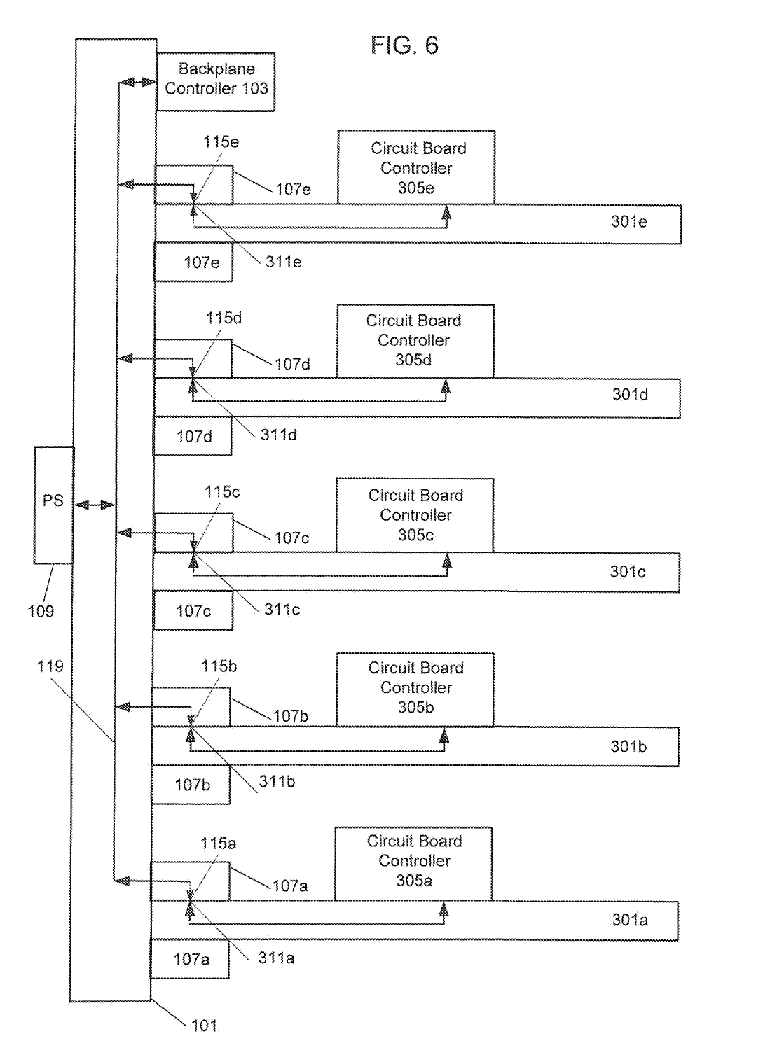

Controller 305 may be electrically coupled to electrical connector 311, optical coupler 303, processor 309, and/or memory 307, and controller 305 may be configured to control coupling/decoupling of circuit board 301 (including processor 309) to/from optical path 111. Moreover, processor 309 may be configured to provide functionality (e.g., server functionality) of circuit board 301 using software and/or applications stored in memory 307. According to some embodiments, circuit board 301 may be inserted into a respective connector 107 of backplane 101, and circuit board controller 305 may initially receive power from power supply 109 (shown in FIG. 6) through electrical connector 311. Circuit board controller 305, however, may be configured to control distribution of power to other elements of circuit board 301 including distribution of power to processor 309 and/or portions thereof.

Upon initial insertion into backplane 101, for example, controller 305 may be configured to communicate with backplane controller 103 through electrical connectors 311 and 115 without providing power to processor 309 and without providing optical coupling through optical coupler 303 and optical bypass switch 105 to optical path 111. While maintaining power off to processor 309 and while maintaining decoupling from optical path 111, circuit board controller 305 may be configured to provide verification information through electrical connectors 311 and 115 to backplane controller 103. Responsive to receiving authorization from backplane controller 103, controller 305 may be configured to provide the enabling signal for optical bypass switch 105 and to provide power to processor 309 so that circuit board 301 may provide a desired functionality (e.g., server functionality) by executing software/applications from memory 307 on processor 309.

More particularly, controller 305 may be configured to provide the enabling signal to optical bypass switch 105 over signal line 315 responsive to authorization from backplane controller 105. Moreover, controller 305 and backplane controller 103 may coordinate timing of actuation of optical bypass switch 105 after processor 309 is powered and ready to operate so that network traffic over optical signal path 111 is not interrupted during actuation. Responsive to receiving the enabling signal from circuit board controller 305, optical bypass switch 105 may be configured to change from a de-actuated state bypassing optical coupler 303 (e.g., as shown in FIG. 2B) to an actuated state to provide coupling between optical path and optical coupler 303 (e.g., as shown in FIG. 2A). Once processor 309 is powered and coupling is provided between optical signal path 111 and optical coupler 303, processor 309 may provide functionality of circuit board 301 including communication (e.g., transmission and reception) of information over optical signal path 111. More particularly, optical signals from optical signal path 111 may be reflected through optical bypass circuit 105 to detector D of optical coupler 303, converted to electrical signals that are provided to transceiver XCVR, and transmitted to processor 309. Electrical signals from processor 309 may be transmitted through transceiver XCVR to emitter E, converted to optical signals by emitter E, and reflected by optical bypass switch 105 to optical signal path 111.

Once the processor 309 is operating with optical coupling to optical signal path 111 through optical coupler 303 and optical bypass switch 105, a similar process can be used (in reverse) to turn the circuit board off. Responsive to an instruction to power down, controller 305 may power down processor 309 while maintaining passage of optical signals through optical coupler 303 so that optical signals received by detector D are replicated by emitter E. Accordingly, controller 311 may coordinate de-actuation of bypass switch with backplane controller 103 so that network traffic on optical signal path 111 is not interrupted when optical bypass switch 105 is de-actuated. Once backplane controller 103 authorizes de-actuation, controller 305 may remove (e.g., turn off) the enabling signal from signal line 315 to change optical bypass switch 105 from an actuated state (e.g., as shown in FIG. 2A) to a de-actuated state (e.g., as shown in FIG. 2B). Once optical bypass switch 105 is de-actuated, optical signals on optical signal path 111 bypass optical coupler 303, and circuit board controller 305 may be powered down. Circuit board 301 may then be removed from backplane 101 without interfering with traffic on optical signal path 111 and without interfering with operation of other circuit boards coupled to the same backplane 101.

As shown in FIG. 3, a separate signal line 315 may be provided from circuit board controller 305 to optical bypass switch 105. According to other embodiments, an electrical coupling between circuit board controller 305 and optical bypass switch 105 may be provided through electrical connectors 311 and 115. By requiring that circuit board controller 305 provide the enabling signal to actuate optical bypass switch 105, optical bypass switch 105 cannot be actuated in the absence of circuit board 301 present at the respective connector 107. Accordingly, optical bypass switch 105 may default to a de-actuated state to insure continuity of the optical path in the absence of at least a minimally operational circuit board. According to other embodiments, however, the enabling signal may be provided/removed by backplane controller 103.

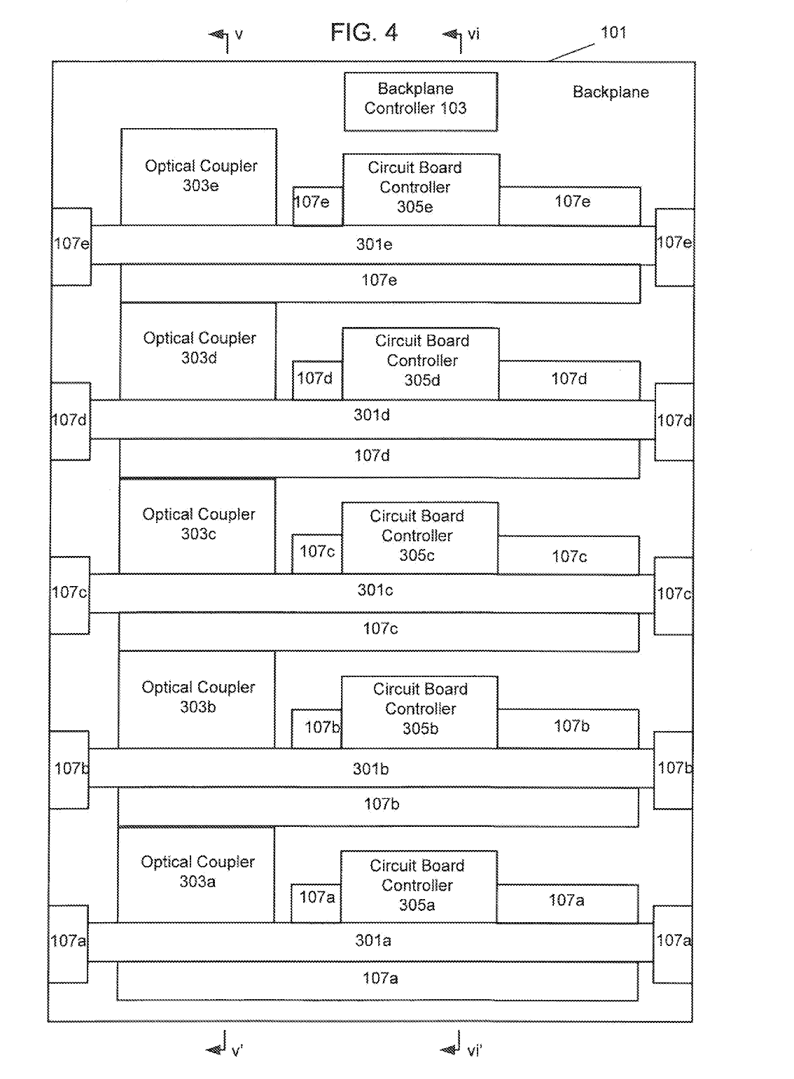

Elements of circuit board 301 and interconnections therebetween that are shown in FIG. 3 are provided by way of example, but more, fewer, and/or different elements and/or interconnections may be provided according to other embodiments. By way of example, direct couplings between processor 309 and electrical connector 311 may be omitted with couplings between processor 309 and electrical connector 311 being provided through circuit board controller 305. Similarly, direct couplings between processor 309 and electrical optical coupler 303 may be omitted with couplings between processor 309 and optical coupler 303 being provided through circuit board controller 305. Moreover, circuit board controller 305, processor 309, memory 307, and/or elements thereof may be implemented and/or illustrated as a same element. In addition, each electrical coupling between elements of FIG. 3 may be provided as a single conductive line or as a plurality of separate parallel conductive lines (e.g., as a bus). For example, bus connections may be provided between circuit board controller 305 and electrical connector 311, between circuit board controller 305 and processor 309, between processor 309 and memory 307, etc. For ease of illustration, memory 307 and processor 309 will be omitted from the illustrations of circuit boards of FIGS. 4-6.

FIG. 4 is a plan view of backplane 101 of FIG. 1 with a plurality of electronic circuit boards 301a to 301e of FIG. 3 mechanically, optically, and electrically coupled to backplane 101, and FIGS. 5 and 6 are cross sectional views taken along section lines v-v′ and vi-vi′ according to some embodiments. As noted above, illustration of memory 307 and processor 309 has been omitted from these figures for ease of illustration, but it will be understood that memory and processor elements may be included. As shown, each circuit board 301a to 301e is inserted in a respective mechanical connector 107a to 107e, with signal lines 315a to 315e providing electrical connection between respective circuit board controllers 305a to 305e and optical bypass circuits 105a to 105e, and with electrical connectors 311a to 311e of circuit boards 301a to 301e electrically coupled to electrical connectors 115a to 115e of backplane 101. As further shown in FIG. 6, electrical signal conductors 119 of backplane 101 may provide electrical coupling between backplane controller 103, backplane power supply (PS) 109, and electrical connectors 115a to 115e. More particularly, electrical signal conductors 119 may include a plurality of different signals conductors. For example, electrical signal conductors 119 may include a data bus with a plurality of parallel data lines providing a plurality of parallel data connections between backplane controller 105 and connectors 115a to 115e. In addition, a separate power line conductor may be provided between power supply 109 and each of backplane controller 105 and connectors 115a to 115e. Moreover, electrical signal conductors 119 may include separate control lines between backplane controller 103 and each of connectors 115a to 115e and/or between backplane controller 103 and power supply 109. Accordingly, a bus including a plurality of separate conductive lines may be provided between backplane controller 103 and each circuit board controller on a circuit board inserted into backplane 101. Electrical signal conductors 119 may thus be use by backplane controller 105 and circuit board controllers 305a to 305e to allow detection of a circuit board by backplane controller 103, to coordinate actuation/de-actuation of an optical bypass switch, and/or to coordinate insertion/removal of a circuit board.

As shown in FIG. 5, optical bypass switches 105a to 105e may be optically coupled in series along optical signal path 111, and each of optical bypass switches 105a to 105e may be selectively actuated to optically couple the respective circuit board to optical signal path 111 or selectively de-actuated to optically decouple the respective circuit board from the optical signal path 111. In the illustration of FIG. 5, all of optical bypass switches 105a to 105e are actuated to illustrate a situation that all of circuit boards 301a to 301e are operating as elements of a networked system providing information over an optical signal path 111 that is shared between all of circuit boards 301a to 301e. Any one or more of circuit boards 301a to 301e, however, may be decoupled from optical signal path 111 by de-actuating the respective optical bypass switch 105a to 105e.

As discussed above, optical bypass switches 105a to 105e may be provided for respective circuit boards 301a to 301e along a same optical signal path 111 to optically couple and/or bypass respective circuit boards 301a to 301e according to some embodiments. According to additional embodiments illustrated in FIGS. 7 and 8, backplane 101 may include a plurality of optical signal paths 111-1 to 111-n, and for each circuit board, an optical bypass switch for each optical signal path. Accordingly, an optical coupler for each circuit board may include a plurality of optical couplers 303-1 to 303-n, each including a respective emitter E and detector D pairs. Stated in other words, each circuit board 301 may include an optical coupler 303-1 to 303-n for each optical signal path, and backplane 101 may include an optical bypass switch 105-1 to 105-n for each optical signal path 111-1 to 111-n for each circuit board 301. Each optical coupler 303a to 303e of each circuit board 301a to 301e may thus be provided according to the structure of FIG. 8 to accommodate a backplane 101 including the plurality of optical signal paths 111-1 to 111-n shown in FIG. 7. Moreover, circuit board controller 305 and/or backplane controller 103 may be configured to separately control each of optical couplers 303-1 to 303-n and to separately control each of optical bypass switches 105-1 to 105-n associate with the circuit board 301.

Each of circuit boards 301a to 301e may thus be optically coupled to some, all, or none of a plurality of optical signal paths 111-1 to 111-n according to some embodiments of the present invention. By selectively coupling different circuit boards 301a to 301e to different ones and/or different combinations of optical signal paths 111-1 to 111-n, different network configurations (e.g., ring, daisy-chain, multi-drop, and/or meshed network configurations) may be provided. In a daisy-chain network configuration, an output of each of optical bypass switches 105a to 105d may be provided to an input of a respective next optical bypass switch 105b to 105e. In a ring network configuration, optical signal path 111 and/or optical signals paths 111-1 to 111-n may be continuous from an output of optical bypass switch 105e to an input of optical bypass switch 105a. In a meshed network configuration with a plurality of optical data paths 111-1 to 111-n, a direct optical coupling may be provided between each circuit board and each of the other circuit boards. Moreover, an optical network configuration of backplane 101 may be changed without requiring re-cabling of optical data paths by changing a configuration of actuated/de-actuated optical bypass switches 105a to 105e. In addition, backplane network may be configured/reconfigured by backplane controller 105 on the fly by coordinating circuit board operations and optical bypass switch actuations/de-actuations as network operations continue.

According to some embodiments, methods of operating a computing system including backplane 101 and circuit boards 301a to 301e may allow insertion and/or removal of one circuit board (e.g., circuit board 301b) while maintaining operation of other circuit boards (e.g., circuit boards 301a and 301c to 301e). In the example of FIG. 9, optical bypass switches 105a and 105c to 105e may be actuated (e.g., as shown in FIG. 2A) to provide optical coupling with circuit boards 301a and 301c to 301e, and optical bypass switch 105b may be de-actuated (e.g., as shown in FIG. 2B) with circuit board 301b removed from mechanical connector 107b. As shown in the flow chart of FIG. 9, upon insertion of circuit board 301b into mechanical connector 107b, backplane controller 103 may detect a presence of circuit board 301b by detecting an electrical coupling with circuit board controller 305a through electrical connectors 311a and 115a at block 901. Once circuit board 301b is inserted into connector 107b, electrical power from power supply 109 may be provided through electrical connectors 115b and 311b to circuit board controller 305b, and the powered circuit board controller 305b may provide control information that is detected by backplane controller 103. Before and after insertion of circuit board 301b, optical bypass switches 105a and 105c to 301e may be actuated (e.g., as shown in FIG. 2A) so that circuit boards 301a and 301c to 301e are optically coupled to optical signal path 111, while optical bypass switch 105b is de-actuated so that optical signal path 111 bypasses circuit board 301b.

Responsive to detecting the presence of the circuit board 301b at block 901, backplane controller 103 may verify compatibility of the circuit board 301b with the computing system at block 903 while continuing to carry optical signals through optical signal path 111 and optical bypass switch 105b bypassing the circuit board 301b. Responsive to verifying compatibility at block 905, backplane controller 103 may authorize circuit board 301b to communicate over the optical signal path 111 at block 907. Responsive to the authorization, processor 309b may be powered up at block 909, and an enabling signal may be generated by circuit board controller 305b to actuate optical bypass switch 105b thereby coupling circuit board 301b to optical signal path 111 at block 911. Powering processor 309b at block 909 may occur before actuating optical bypass switch 105b at block 911 as shown in FIG. 9 so that processor 309b is ready to process optical signals received and transmitted through optical coupler 303b when optical bypass switch 105b is activated. According to other embodiments, optical bypass switch 105b may be actuated before powering processor 309b, and optical coupler 303b may retransmit optical signals received at detector D from emitter E to maintain continuity of optical signal path 111 until processor 309b is ready to process optical information. Once circuit board 301b is coupled to optical signal path 111 and processor 309b is powered, circuit board 301b may provide its intended functionality (e.g., as a server) for the computing system supported by backplane 101 at block 915.

Circuit board 301b may later be powered off and/or removed, for example, to provide a system upgrade and/or repair, and/or to automatically shut down a circuit board responsive to detecting a error/malfunction of the circuit board 301b. A deactivation signal for circuit board 301b may be generated, for example, responsive to user input (e.g., through circuit board 301b and/or through backplane controller 103). In addition or in an alternative, a deactivation signals may be automatically generated responsive to an error/malfunction detected at circuit board controller 305b and/or at backplane controller 103. Responsive to a deactivation signal at block 917, circuit board 301b may be decoupled from the optical signal path 111 by removing the enabling signal thereby de-actuating optical bypass switch 105b. In addition, power to processor 309b may be turned off at block 917 responsive to receiving the deactivation signal. Once optical bypass switch 105b has been de-actuated and power to processor 309b has been turned off, circuit board 301b may be removed from connector 107b without interrupting optical signal transmission along optical signal path 111.

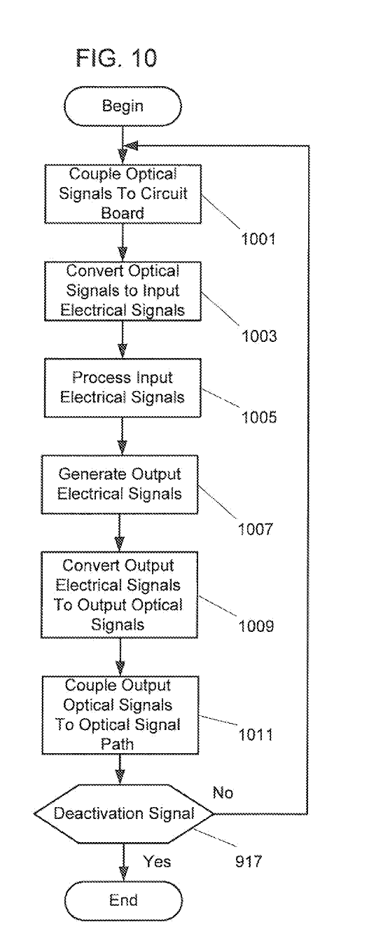

FIG. 10 is a flow chart illustrating operations of providing circuit board functionality of block 915. Once optical bypass switch 105b is actuated and processor 309b is powered, optical signals may be coupled from the optical signal path 111 through optical bypass switch 105b to detector D of optical coupler 303b on circuit board 301b at block 1001. These optical signals may be converted by detector D to input electrical signals at block 1003 that are transmitted through transceiver XCVR to processor 309b. Processor 309b may process the input electrical signals at block 1005, and processor 309b may generate output electrical signals at block 1007 responsive to processing the input electrical signals. The output electrical signals may be transmitted through transceiver XCVR to emitter E of optical coupler 303b, and emitter E may convert the output electrical signals to output optical signals at block 1009. The output optical signals may then be coupled through optical bypass switch 105b to optical signal path 111 at block 1011. Operations of FIG. 10 may continue, for example, until a deactivation signal is detected as discussed above with respect to block 917 of FIG. 9.

As discussed above with respect to FIGS. 2A, 2B, and 3, circuit board controller 305 may be may be configured to generate an enabling signal to actuate a respective optical bypass switch 105 (e.g., as shown in FIG. 2A) to provide optical coupling between circuit board 301 and optical signal path 111 of backplane 101. In the absence of the enabling signal from circuit board controller 305, optical bypass switch 105 may be de-actuated (e.g., as shown in FIG. 2B) so that optical signals on optical signal path 111 bypass circuit board 301. In addition, circuit board controller 305 may control a characteristic (e.g., an amplitude, frequency, etc.) of the enabling signal to improve a coupling between optical signal path and emitter E and/or detector D of optical coupler 303. Circuit board controller 305, for example, may apply enabling signals having different characteristics (e.g., different amplitudes) to optical bypass switch 105 and measure resulting signal strengths of optical signals received through detector D. Circuit board controller 305 may then select the characteristic (e.g., amplitude) for the enabling signal corresponding to the greatest signal strength, and the selected characteristic (e.g., amplitude) may be used when subsequently actuating optical bypass switch 105. Accordingly, circuit board controller 305 can select a characteristic of the enabling signal to compensate for misalignment of optical coupler 303 relative to optical bypass switch 105, to compensate for manufacturing variations of different optical bypass switches and/or optical couplers, etc. If optical bypass switch 105 is implemented with MEMS mirrors that are actuated electrostatically, different amplitudes of the enabling signal may provide different degrees of actuation of the mirrors to allow a coupling between optical signal path 111 and emitter/detector E/D to be tuned.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed is:

1. A backplane for a computing system, the backplane comprising:
a connector configured to provide a detachable mechanical coupling with a circuit board;
an optical signal path configured to carry optical signals; and
an optical bypass switch configured to couple optical signals from the optical signal path to the circuit board and to couple optical signals from the circuit board to the optical signal path responsive to an enabling signal, and configured to transmit optical signals therethrough to bypass the circuit board responsive to an absence of the enabling signal.

2. A backplane according to claim 1 wherein the connector comprises a first connector, wherein the optical bypass switch comprises a first optical bypass switch, wherein the circuit board comprises a first circuit board, and wherein the enabling signal comprises a first enabling signal, the backplane further comprising:
a second connector configured to provide a detachable mechanical coupling with a second circuit board; and
a second optical bypass switch, wherein the first and second optical bypass switches are optically coupled in series along the optical signal path of the backplane,
wherein the second optical bypass switch is configured to couple optical signals from the optical signal path to the second circuit board and to couple optical signals from the second circuit board to the optical signal path responsive to a second enabling signal, and
wherein the second optical bypass switch is configured to transmit optical signals therethrough to bypass the second circuit board responsive to an absence of the second enabling signal.

3. A backplane according to claim 1,
wherein the optical bypass switch comprises first and second mirrors,
wherein the first mirror is configured to reflect the optical signals from the optical signal path to the circuit board responsive to the enabling signal and wherein the second mirror is configured to reflect the optical signals from the circuit board to the optical signal path responsive to the enabling signal, and
wherein the first and second mirrors are configured to allow passage of the optical signals from the optical signal path without reflecting the optical signals from and to the circuit board responsive to the absence of the enabling signal.

4. A backplane according to claim 1 wherein the optical signal path comprises a first optical signal path, wherein the optical signals comprise first optical signals, and wherein the optical bypass switch comprises a first optical bypass switch, the backplane further comprising:
a second optical signal path configured to carry second optical signals; and
a second optical bypass switch configured to couple optical signals from the second optical signal path to the circuit board and to couple optical signals from the circuit board to the second optical signal path responsive to a second enabling signal, and configured to transmit the second optical signals therethrough to bypass the circuit board responsive to an absence of the second enabling signal.

5. A backplane according to claim 1 wherein the connector further comprises an electrical connector configured to provide a detachable electrical coupling with the circuit board, the backplane further comprising:
a backplane controller electrically coupled to the electrical connector wherein the backplane controller is configured to detect a presence of the circuit board in the connector, to verify compatibility of the circuit board with the backplane while the optical bypass switch transmits optical signals therethrough bypassing the circuit board responsive to the absence of the enabling signal, and to authorize the enabling signal responsive to verifying the compatibility of the circuit board.

6. A circuit board configured to operate in a computing system including an electrical connector, an optical signal path, and an optical bypass switch configured to couple optical signals from the optical signal path to the circuit board and to couple optical signals from the circuit board to the optical signal path responsive to an enabling signal and to transmit optical signals through the optical bypass switch to bypass the circuit board responsive to an absence of the enabling signal, the circuit board comprising:
an electrical connector configured to provide a detachable electrical coupling with the electrical connector of the computing system;
an optical coupler configured to provide an optical coupling with the optical path through the optical bypass switch of the computing system, wherein the optical coupler includes a detector configured to receive optical signals from the optical bypass switch and an emitter configured to transmit optical signals to the optical bypass switch; and
a controller electrically coupled to the electrical connector and to the optical coupler, wherein the controller is configured to provide verification information through the electrical connector to the computing system without providing the enabling signal, and to provide the enabling signal for the optical bypass switch responsive to receiving authorization from the computing system.

7. A circuit board according to claim 6 further comprising:
a processor coupled to the controller, wherein, while the controller is providing the enabling signal, the processor is configured to receive information responsive to optical signals received through the optical signal path and coupled through the optical bypass switch to the detector of the optical coupler, and to transmit information through the emitter of the optical coupler and the optical bypass switch to the optical signal path.

8. A circuit board according to claim 7 wherein the controller is configured to withhold power from the processor while providing the verification signals, and wherein the controller is configured to provide power to the processor responsive to receiving the authorization from the computing system.

9. A circuit board according to claim 6 wherein the optical coupler comprises a first optical coupler, wherein the optical signal path comprises a first optical signal path, wherein the optical bypass switch comprises a first optical bypass switch, wherein the computing system further includes a second optical signal path, and a second optical bypass switch configured to couple optical signals from the second optical signal path to the circuit board and to couple optical signals from the circuit board to the second optical signal path responsive to a second enabling signal and to transmit optical signals through the second optical bypass switch to bypass the circuit board responsive to an absence of the second enabling signal, the circuit board comprising:
a second optical coupler configured to provide an optical coupling with the second optical path through the second optical bypass switch of the computing system, wherein the second optical coupler includes a second detector configured to receive optical signals from the second optical bypass switch and a second emitter configured to transmit optical signals to the second optical bypass switch,
wherein the controller is electrically coupled to the second optical coupler, wherein the controller is configured to provide the second enabling signal for the second optical bypass switch responsive to receiving the authorization from the computing system.

10. A computing system comprising:
a circuit board including an optical coupler; and
a backplane including,
a connector providing a detachable mechanical coupling with the circuit board,
an optical signal path configured to carry optical signals, and
an optical bypass switch configured to couple optical signals from the optical signal path to the optical coupler of the circuit board and to couple optical signals from the optical coupler of the circuit board to the optical signal path responsive to an enabling signal, and configured to transmit optical signals therethrough to bypass the circuit board responsive to an absence of the enabling signal.

11. A computing system according to claim 10 wherein the circuit board comprises a first circuit board, wherein the connector comprises a first connector, wherein the optical bypass switch comprises a first optical bypass switch, and wherein the enabling signal comprises a first enabling signal, the computing system further comprising:
a second circuit board including a second optical coupler;
a second connector providing a detachable mechanical coupling with the second circuit board; and
a second optical bypass switch, wherein the first and second optical bypass switches are optically coupled in series along the optical signal path,
wherein the second optical bypass switch is configured to couple optical signals from the optical signal path to the second circuit board and to couple optical signals from the second circuit board to the optical signal path responsive to a second enabling signal, and
wherein the second optical bypass switch is configured to transmit optical signals therethrough to bypass the second circuit board responsive to an absence of the second enabling signal.

12. A computing system according to claim 10,
wherein the optical bypass switch comprises first and second mirrors,
wherein the first mirror is configured to reflect the optical signals from the optical signal path to the optical coupler of the circuit board responsive to the enabling signal and wherein the second mirror is configured to reflect the optical signals from the optical coupler of the circuit board to the optical signal path responsive to the enabling signal, and
wherein the first and second mirrors are configured to allow passage of the optical signals from the optical signal path without reflecting the optical signals to and from the circuit board responsive to the absence of the enabling signal.

13. A computing system according to claim 10 wherein the optical signal path comprises a first optical signal path, wherein the optical signals comprise first optical signals, and wherein the optical bypass switch comprises a first optical bypass switch, the computing system further comprising:
a second optical signal path configured to carry second optical signals; and
a second optical bypass switch configured to couple optical signals from the second optical signal path to optical coupler of the circuit board and to couple optical signals from the optical coupler of the circuit board to the second optical signal path responsive to a second enabling signal, and configured to transmit the second optical signals therethrough to bypass the circuit board responsive to an absence of the second enabling signal.

14. A computing system according to claim 10 wherein the connector further comprises an electrical connector configured to provide a detachable electrical coupling with the circuit board, the backplane further comprising:
a backplane controller electrically coupled to the electrical connector wherein the backplane controller is configured to detect a presence of the circuit board in the connector, to verify compatibility of the circuit board with the backplane while the optical bypass switch transmits optical signals therethrough bypassing the circuit board responsive to the absence of the enabling signal, and to authorize the enabling signal responsive to verifying the compatibility of the circuit board.

15. An optical bypass circuit comprising:
a body configured to provide optical coupling with input optical signals and with output optical signals;
a first mirror adjacent the input optical signals wherein the first mirror is configured to provide optical coupling between the input optical signals and an optical detector outside the body responsive to an enabling signal and wherein the first mirror is configured to optically bypass the optical detector responsive to an absence of the enabling signal; and
a second mirror adjacent the output optical signals wherein the second mirror is configured to provide optical coupling between an optical emitter and the output optical signals responsive to the enabling signal and wherein the second mirror is configured to optically bypass the optical emitter responsive to the absence of the enabling signal.

16. An optical bypass circuit according to claim 15 wherein the first and second mirrors comprise first and second microelectromechanical system (MEMS) mirrors configured to move to respective first positions responsive to the enabling signal and to move to respective second positions responsive to the absence of the enabling signal.

17. A method of operating a computing system comprising a backplane including a connector configured to provide a detachable mechanical coupling with a circuit board, an optical signal path, and an optical bypass switch serially coupled along the optical signal path, the method comprising:
responsive to detecting a presence of the circuit board, verifying compatibility of the circuit board with the computing system while carrying optical signals through the optical signal path bypassing the circuit board through optical bypass switch;
responsive to verifying compatibility, providing authorization for the circuit board to communicate over the optical signal path; and
responsive to the authorization, actuating the optical bypass switch to couple the circuit board to the optical signal path through the optical bypass switch.

18. A method according to claim 17 further comprising:
after actuating the optical bypass switch, coupling optical signals from the optical signal path through the optical bypass switch to the circuit board;
converting the optical signals to input electrical signals;
processing the input electrical signals;
responsive to processing the input electrical signals, generating output electrical signals;
converting the output electrical signals to output optical signals; and
coupling the output optical signals through the optical bypass switch to the optical signal path.

19. A method according to claim 17 wherein verifying compatibility of the circuit board comprises verifying compatibility without powering a processor of the circuit board, the method further comprising:
responsive to verifying compatibility, powering the processor on the circuit board.

20. A method according to claim 17 further comprising:
responsive to a deactivation signal, de-actuating the optical bypass switch to decouple the circuit board from the optical signal path; and
responsive to the deactivation signal, turning power off to the processor.
